(19) United States
(12) Patent Application Publication
(10) Pub. No.: US 2018/0248756 A1
(43) Pub. Date: Aug. 30, 2018

(54) SYSTEM, DEVICE AND METHOD FOR USE IN A SOFTWARE DEFINED CONTROL APPLICATION

(71) Applicant: PHILIPS LIGHTING HOLDING B.V., EINDHOVEN (NL)

(72) Inventor: BJORN CHRISTIAAN WOUTER KAAG, EINDHOVEN (NL)

(21) Appl. No.: 15/755,534

(22) PCT Filed: Aug. 1, 2016
(86) PCT No.: PCT/EP2016/068322

§ 371 Date: Feb. 26, 2018

(30) Foreign Application Priority Data
Aug. 31, 2015 (EP) 15183126.0

(51) Int. Cl. H04L 12/24; H04L 12/725

(52) U.S. Cl. CPC H04L 41/0833; H04L 45/30

(57) ABSTRACT

The present invention provides a management system enabled to control power modes of the network components, such as data forwarding components as well as end nodes, e.g. application control components, according to a global application plan. Controlling the power modes may comprise switching off network components of the control network or parts thereof to save energy without losing capabilities of said control network. For instance, a data-forwarding device having switchable data port can be used to switch off communication paths “in efficio” through the control network, especially if the end node is a PoE device. Furthermore, a protocol to receive a schedule for unattended operation is provided, thereby enabling improved energy usage.

### FIELD OF THE INVENTION

The present invention relates to application control networks, e.g. —but not limited to—lighting control networks. In particular the invention relates to the efficient use of the network components in dependence of application requirements as well as network topologies.

### BACKGROUND OF THE INVENTION

In application control networks, such as—but not limited to—lighting control networks, data forwarding devices, are used to forward messages between different application control components, such as sensors and actuators of a lighting application.

It is known from Heller et al, “ElasticTree: Reducing Energy in Data Center Networks”, that present data-forwarding devices like data switches are inefficient at low load. Presently, when being in an idle status—that is powered but not used for communication—a typical data switch uses only 5% less power compared to the status in which the data switch is fully loaded with data transmission.

From WANG RUI et al: “Energy-aware routing algorithms in Software-Defined Networks” a dynamic energy aware routing algorithm in software defined networks is known in which a global power management for routers is realized by rerouting traffic through different paths to adjust the workload of links when the network is relatively idle. In order to set respective line-cards of the routers to sleep, respective routing paths are chosen such that a minimum number of line-cards is affected by the routing paths.

In wired lighting control environments a lighting device may be powered via Power over Ethernet (i.e. PoE). A PoE data switch is an all ports on/off device, just like a normal Ethernet data switch without PoE functionality. A typical PoE data switch will thus require a relative high additional power budget to “keep the line alive”. This is standardized in Ethernet standard “802.3at” (i.e. “Eight-oh-two-dot-three-Alfa-Tango”).

The communication components (such as e.g. a data switch or router) in the control will consume power. The Ethernet standard 802.3at for PoE requires a minimum standby power of 250 mW per port. In big installation with many nodes this amounts to large standby power, not only from data communication equipment such as e.g. data switches and routers but also from the nodes that are attached thereto, such as electrical actuators/loads or sensors. This causes several problems:
Large standby power generates heat and degrades the life of electronics, unless it is overdesigned to cope with that, which results in extra cost.
Application end notes with large energy saving potentials such as LED's in the lighting sector, may become less substantial due to the standby power consumed by the data communication network.
More ambitious requirements on “Energy Performance Calculations” for new buildings and/or renovations and reductions in energy use are expected in the context of sustainability.
Energy loss in itself results in non negligible costs in moderate to large buildings.
Energy loss of devices usually heats the surrounding air, which requires additional cooling, which in itself consumes additional energy and thus produces costs.

Alternatively to reducing the total load of idle energy consumption on the data switch itself or even on the individual loads, it may be considered to switch off network components during times of low occupancy. However, the indiscriminate switching on and off of particular nodes in the (lighting) control network may degrade the capabilities of that (lighting) control network in ways that are totally unanticipated. For instance, switching off a data switch or a data port on the data switch may result in indirectly switching off the node that was connected to such a data port on the data switch, especially if the end node has no alternative source of power (PoE device). Furthermore, certain communication paths may be interrupted such that message delivery is unduly prolonged or even impossible.

An emerging technology to control network traffic is Software Defined Networking (i.e. SDN), as explained in for example “SDN—Software Defined Networks”, Thomas D. Nadeau and Ken Gray, O'Reilly, 2013, ISBN: 978-1-449-34230-2. In software defined networks the element of abstraction is the data switch of the communication network. An SDN enabled data switch does not have local intelligence to make the decision how to route data through the network since all routing and filtering is moved to an SDN controller entity. A properly programmed SDN controller is capable of selecting a communication path out of the plurality of possible communication paths between end nodes, e.g. application control devices. The SDN controller will provide the correct filters to pass data from A to Ω as depicted in FIG. 1a. The SDN controller can answer the simple question if network components can see each other, abstracting all the steps in between as depicted in FIG. 1b.

Hence, a network management controller, such as an SDN controller, is providing infrastructure to abstract and automate network configuration (programming of communication paths). SDN itself though has no context information regarding a control application run via the communication network. Therefore, the communication paths programmed to route messages through the network are solely determined based on network topologies.

### SUMMARY OF THE INVENTION

It is an object of the present invention to enhance the efficiency of an application control network, in particular reducing the energy consumption, while guaranteeing a required functionality and quality of service.

The object is achieved by the subject matter of the independent claims. Further embodiments are shown by the dependent claims.

A basic idea of the present invention is to provide a management system enabled to control power modes of the network components, such as data forwarding components as well as end nodes, e.g. application control components, in accordance with a global application control plan. Controlling the power modes may comprise switching off network components of the control network or parts thereof to save energy without losing capabilities of said control network. For instance, a data-forwarding device having switchable data ports can be used to switch off communication paths “in efficio” through the control network, especially if the end node is a PoE device. In order to determine the communication paths necessary for proper service of the control application, the management system requires additional knowledge regarding the application usage. Within the context of the present application communication path shall cover any communication (control commands or data communication) passed through a network, e.g. data communication covers both level 2 data passing and level 3 data routing in accordance with the ISO model.

In an aspect of the invention there is provided a method for controlling data routing within a control system comprising a plurality of network components, wherein the method comprises:
determining a first application scene defining one or more first destination devices among the plurality of network components to be controlled upon receipt of a message from one or more first source devices among the plurality of network devices;
selecting one or more respective communication paths through the network for communication between the one or more first source devices and the one or more first destination devices based on an optimization of a predetermined parameter with respect to the first application scene,
configuring the network components to use the one or more selected communication paths from the plurality of communication paths for data routing; and
providing instructions to the network components which are not located along the one or more selected communication paths to operate in a power saving mode for a predetermined time given by the first application scene, wherein the network components in the power saving mode are not responsive to any network requests or messages.

Within the context of software defined application systems an application scene defines a particular way how to control the application. For instance, a lighting scene defines which sensor inputs result in activation of specific loads, e.g. which lights are switched on. In the lighting application example a destination device may be a load receiving an activation command from one of the sensors as source device. However, communication could be the other way round, e.g. upon activation of a particular light in a room a sensor, for instance a sensor controlling the day light adapted to dim the light accordingly, is switched on. In any case the data message send between source and destination device is routed via a plurality of network components, e.g. data forwarding devices. Depending on the number of data forwarding devices present within the network, there will be a vast variety of possible communication paths between source and destination device. Wherein simple network management systems may only select a path based on criteria such as minimal number of nodes, e.g. number of intermediate devices, such as data forwarding devices along a communication path, more sophisticated management systems may exploit application related data to optimize the communication path selection. For instance, in order to minimize energy consumption it may not always be the shortest way that results in the largest energy savings. For instance, when an application scene comprises more than one destination device and/or source device, e.g. two loads controlled by one or two sensors, the optimal path in terms of minimal energy consumption may not necessarily be a combination of the two shortest ways between the source device and the respective destination devices. It may be that a combination of two slightly longer single communication paths which share lots of network components along the communication path results in even larger energy savings. Furthermore, the management system may have knowledge about the respective energy consumptions of the network components, e.g. stored in a database. Hence, upon determining the possible communication paths, the management system may conclude that in order to minimize an overall energy consumption a path using two data forwarding devices requiring 10 W is more energy efficient than using a path with only one data forwarding device requiring 30 W. Hence, combining knowledge from the network layer and the application layer may result in further improving the communication path selection based on a predetermined parameter. Besides the overall energy consumption the predetermined parameter could also be any other criteria such as time, frequency, duration, occupancy, etc. Those network components or parts thereof which are not located along the selected communication path may be operated in a power saving mode, e.g. set to a hibernate mode, in which they require less power than during normal operation, e.g. on or idle mode, but in which they are also not responsive anymore to any network requests or messages, e.g. not available for any data routing or data passing. Accordingly, by switching off network components which are not required according to a particular application control scene, the system may save significant energy, in particular if the network components is a data forwarding device serving end nodes which are powered via the network. In that case the entire data communication path is switched off for a predetermined time in accordance with the application scene.

In an embodiment of present invention the method further comprises:
determining a second application scene defining a second destination device of the plurality of network devices to be controlled upon receipt of a message from a second source device of the plurality of network devices; wherein the second application scene precedes, follows or overlaps with the first application scene;
determining a second plurality of communication paths through the network for communication between the second source device and the second destination device;
selecting one or more respective communication paths from the second plurality of communication paths;
wherein selecting one or more respective communication paths from the first and second plurality of communication paths is based on an optimization of a predetermined parameter with respect to the first and second application scene.

Basing the path selection not only on a first application scene but taking into account interactions with a second application scene which may be applied in parallel or in interleaved fashion may allow enhancing the efficiency with respect to data routing further. For instance, in case of partial overlaps between the application scenes it may be more energy efficient to use slightly longer communication paths with respect to the individual application scenes but that share a lot of network components along these slightly longer paths. A further example may be an application of two application scenes in an interleaved fashion. Again it may be beneficial to select a resulting set of communication paths which is not the optimal path for each individual application scene but may require less changes in the operation mode of network components which may be used in common. This may be desirable in terms of the overall energy consumption or in view of the lifecycle of the network components, in particular when the durations of the interleaved application scenes are rather short.

In an embodiment of the present invention the plurality of network components comprise at least one data-forwarding device along the one or more selected communication paths, wherein the data-forwarding device comprises one or more data ports and the method further comprises: providing instructions to the at least one data-forwarding device to operate the one or more data ports of the data-forwarding device which are not required for data communication along the one or more selected communication paths in a power saving mode. Wherein switching off an entire data forwarding device would cut off any communication paths supported by that data forwarding device, it may be desirable to switch off single data ports of the data forwarding device while other data ports may still be used for data forwarding. Hence, when the data forwarding device provides switchable data ports the system is capable of controlling data routing down to data port level. The data forwarding device may thus be operated in a very efficient way by only powering those data ports used for data routing in accordance with a respective application scene.

In an embodiment of the present invention the method further comprises periodically updating the first plurality of communication paths and if a new communication path is added or a communication path is removed, repeat the steps of selecting, configuring and providing instructions using the updated first plurality of communication paths. By periodically monitoring the available communication paths through the network and comparing the monitored status with the record, it may be determined that a path was added or removed. In that case the method steps of selecting, configuring and providing instructions should be repeated to provide the optimal path selection and avoid deadlinks due to removed or dysfunctional network components.

In an embodiment of the present invention the first application scene is determined from a usage pattern monitored during application usage, manually entered or uploaded from another storage source. Since the application scenes strongly depend on the concrete application, the respective application pattern and time slots of an application scene may be learned by the system from monitoring the application usage. Application data may be collected and reoccurring patterns may be extracted and used to define an application scene. These scenes may be continuously updated and respective communication paths can be determined. For example, the system may observe via a presence sensor that between 2 am and 6 am only frequently a person traverses the entrance of a building, e.g. the night guard. However, the night guard will not switch on any light within the building or power a workstation. Hence, there is no need to power up any network devices within the network system. At 7 am several people pass the presence sensor at the entrance hall in rather short distances and subsequently power upon their workstation and switch on lights in their office area. The application system may monitor the patterns and extract them upon first or regular occurrence and add corresponding application scenes to a combined application plan. Alternatively or additionally an application scene may be manually entered or could be downloaded from a storage source, such as a server or data base, e.g. weekends and holidays.

In an embodiment of the present invention the method comprises
generating respective time schedules for the network components defining operation states for the respective network components for respective time slots according to the first and second application scenes, and
providing the time schedules to the respective network components.

The knowledge about required communication paths from different application scenes may be compiled in a time schedule defining an operation state of a network component, e.g. either entire component on/off or parts thereof, e.g. single data ports of a data forwarding device. The time schedule ensures that the network components will be active in the time slots it is required for data communication and enables saving energy by defining time slots in which a device or components thereof may be sent to a power saving mode.

In another aspect of the invention there is provided a computer program executable in a processing unit, the computer program comprising program code means for causing the processing unit to carry out a method as defined in previous aspect of the invention when the computer program is executed in the processing unit.

In another aspect of the invention there is provided a system for controlling data routing within a control network, the system comprising:

an application control unit for determining a first application scene defining one or more first destination devices among the plurality of network components to be controlled upon receipt of a message from one or more first source devices among the plurality of network devices;

a network control unit for determining a first plurality of communication paths through the network for communication between the one or more first source devices and the one or more first destination devices;

logic for selecting one or more respective communication paths from the plurality of communication paths based on an optimization of a predetermined parameter with respect to the first application scene,

wherein the network control unit is adapted to program the network components to use the one or more selected communication paths from the plurality of communication paths for data routing; and

wherein the application control unit is adapted to provide instructions to the network components which are not located along the one or more selected communication paths to operate in a power saving mode for a predetermined time given by the first application scene, wherein the network components in the power saving mode are not responsive to any network requests or messages.

In an embodiment of the present invention the application control unit is further adapted to determine a second application scene defining a second destination device of the plurality of network devices to be controlled upon receipt of a message from a second source device of the plurality of network devices; wherein the second application scene precedes, follows or overlaps with the first application scene;

the network control unit is further adapted to determine a second plurality of communication paths through the network for communication between the second source device and the second destination device;

the logic is further adapted to select one or more respective communication paths from the first and second plurality of communication paths based on an optimization of a predetermined parameter with respect to the first and second application scene.

In an embodiment of the present invention the plurality of network components comprises at least one data-forwarding device along the one or more selected communication paths, wherein the data-forwarding device comprises one or more data ports and the application control unit is further adapted to provide instructions to the at least one data-forwarding device to operate the one or more data ports of the data-forwarding device which are not required for data communication along the one or more selected communication paths in a power saving mode.

In an embodiment of the present invention the application control unit comprises a monitoring unit for monitoring application patterns during operation of an application to extract the first application scene.

In an embodiment of the present invention the application control unit is further adapted to generate application schedules for unattended operation for the plurality of network components.

In an embodiment of the present invention the control network is shared by at least two application networks, and the system further comprises a second application control unit for determining a third application scene for a second application defining one or more destination devices among the plurality of network components to be controlled upon receipt of a message from one or more source devices among the plurality of network devices;

wherein the network control unit is adapted to determine a third plurality of communication paths through the network for communication between the one or more source devices and the one or more destination devices of the second application; and

wherein the logic is adapted to select one or more respective communication paths from the first and third plurality of communication paths based on an optimization of a predetermined parameter with respect to the first and third application scene.

Having more than one control application using the same communication network may require to establish communication between the application control units in order to avoid that one control application cuts off a communication path required by the other application. Therefore, the logic determining the communication paths required during a specific time may receive input from both control application units and provides control instructions via a shared network control unit.

In an embodiment of the present invention the control network is shared by at least two application networks, and the system further comprises a second application control unit for determining a third application scene for a second application defining one or more destination devices among the plurality of network components to be controlled upon receipt of a message from one or more source devices among the plurality of network devices; wherein the system comprises a second network control unit for determining a third plurality of communication paths through the network for communication between the one or more source devices and the one or more destination devices of the second application; and wherein the logic is adapted to select one or more respective communication paths from the first and third plurality of communication paths based on an optimization of a predetermined parameter with respect to the first and third application scene, and wherein the respective network control units are adapted to program the network components to use the one or more selected communication paths from the plurality of communication paths for data routing. Having more than one control application using the same communication network may require to establish communication between the application control units in order to avoid that one control application cuts off a communication path required by the other application. The logic determining the communication paths required during a specific time may provide aligned time schedules to different network control units.

It shall be understood that the method of claim 1, the computer program for controlling data routing of claim 8, and the system according to claim 9 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

FIGS. 1a and 1b illustrate the abstraction level of a state of the art software defined control system.

FIG. 2 shows an arbitrary building plan with lights and sensors.

FIG. 3 shows an arbitrary lighting plan with hallway lights grouped on exclusive switch (S11).

FIG. 4 shown an exemplary embodiment of a domain model for energy efficient application control.

FIGS. 5a-c illustrate possible communication paths for switching lighting control scenes 1 and 2, in arbitrary sequence.

FIGS. 6a-c illustrate a best path selection analysis.

FIG. 7 shows a flow diagram for computing the time schedule to program the control lines.

FIG. 8 shows an exemplary best path computation.

FIG. 9 shows example integration of a control application with other control application domains.

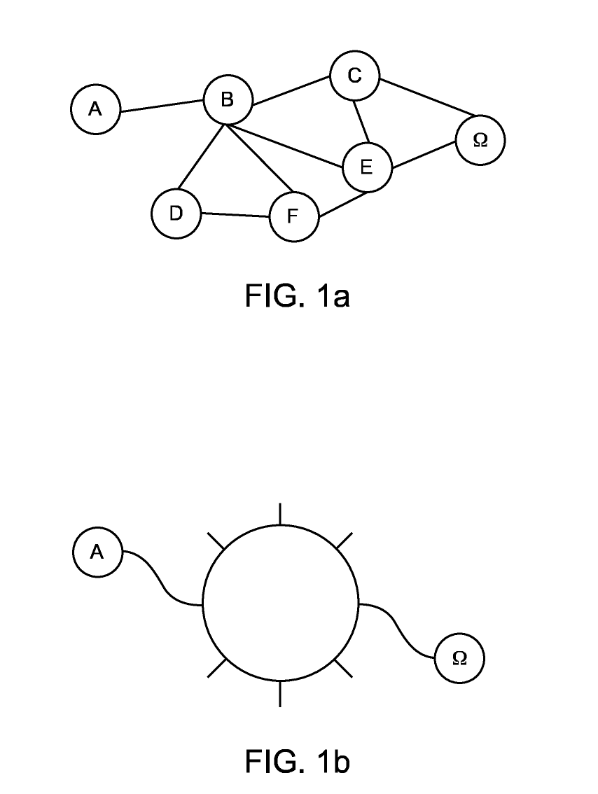

### DETAILED DESCRIPTION OF EMBODIMENTS

Embodiments are now described based on a lighting control system. However, it is to be understood that the embodiments are not restricted to lighting control systems. The person skilled in the art will appreciate that the outlined approach may be exploited in any other control system having a similar topology, e.g. using a combination of sensor(s) and/or actuators.

In some embodiments a management system 200, such as a software defined control (SDC) system, may comprise a software defined application (SDA) system and a network management system, such as a software defined networking (SDN) system. The SDA provides information about all application control components, e.g. actuators and sensors, in an application plan, comprising various application scenes. Application specific interactions between application components such as sensors and actuators are defined as application scenes in the application plan. For instance, in a lighting control system, as an example of an application control system, a lighting scene may define which lamps in a room should be switched on if a presence detector detects a person entering a room. The lamps and detectors represent possible application control components. The management system maps the application control components comprised in the respective application scenes onto the communication network topology, thus providing an application control scene which subsequently allows configuring communication paths through the network and decide which network components within the control network need to be powered to pass on commands between the application control components in accordance with the defined application scenes. If not required, the network components are or remain switched off, without degrading the capability of the (lighting) control network to execute (lighting) control scenes.

In some embodiments a fully automated lighting control system is presented that saves energy by analysing all communication paths in a lighting control scene, that can be used in the interaction with the (subset of) sensors and actuators in the associated space or spaces of a building, and select the path that results in minimal energy use of all components in that communication path. Knowledge, accumulated from the particular lighting control application is used to select the path based on criteria such as time, frequency, duration, energy usage, etc. For instance, based on optimization techniques, the system may predict and pro-actively minimize energy usage of the communication paths for all control scenes, taking into account overlay and interactions between application scenes as well as optimize the energy consumption in a single application scene, either by taking into account energy consumption of single network components or in case of serving more than one network component optimize the paths for all network components together. The time as optimization parameter can be used to investigate if a certain time of the day or night is allowing a more optimal usage of the communication paths. For example, in addition to using differences in energy consumption of alternative communication paths, it may be more appropriate to simply have periods where communication paths are either absolutely required or on the contrary not required to be present at all. The duration may be used as threshold to handle certain events of a certain duration differently. For example, it could be beneficial to ignore events of very short duration in particular in view of the life cycle of the network components, and not continuously switch these components off and on. The optimization may also be performed in view of equally distributing data traffic within the communication network. Any parameter which can be extracted from one or more application scenes may be used as well as any appropriate optimization approach.

In a communication network that is shared with other control applications, control applications may interact with one another to improve decisions regarding the maximum overall energy savings and avoid fratricide.

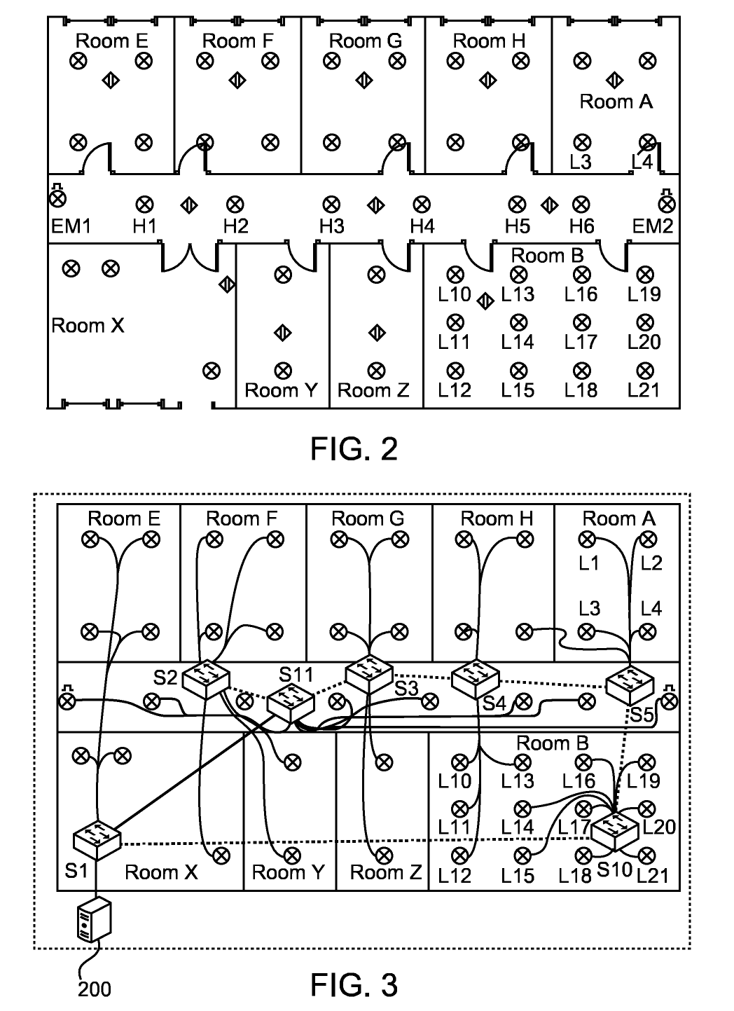

FIG. 2 shows an arbitrary building plan, which identifies individual rooms with lighting control components, such as lights and sensors in each room. A corresponding control plan, e.g. a lighting control plan, defines several light control scenes, e.g. which lights (i.e. electrical load) need to be switched on in a particular room when a particular lighting control sensor (such as e.g. a Passive InfraRed/PIR presence detector) receives a signal from a person walking into a room. The trigger to switch the load may also be generated by any other sensor, such as e.g. a camera, a switch, a door contact, etc.

An exemplary lighting control scene may define that if there is no one present in any of the rooms depicted in FIG. 2, e.g. if no input from the presence detectors is received, the lights may be switched off in all of the rooms. In accordance with this lighting control scene, a lighting control application running on a network controller may map the lighting control plan to the network topology and accordingly switch off not only all lights and sensors that are not used according to the lighting control scene but also all data-forwarding devices which are not needed when only the hall is to be lighted.

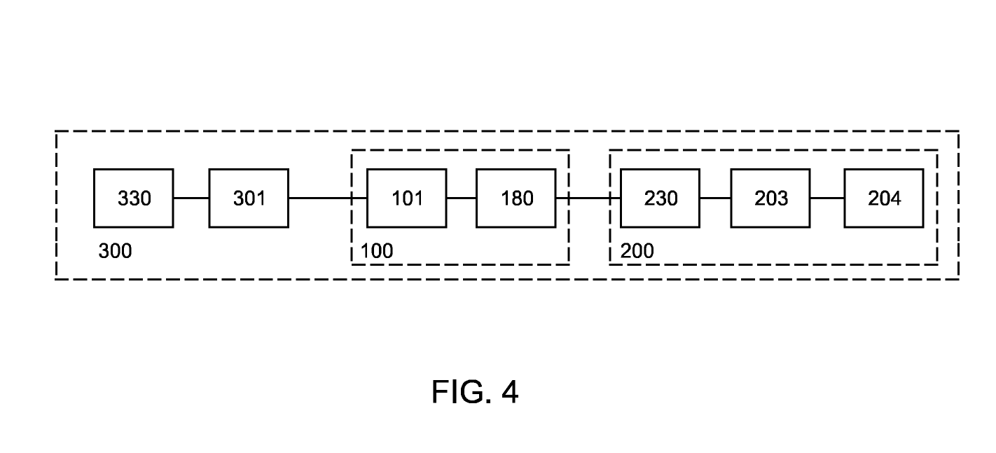

FIG. 3 illustrates a possible corresponding network topology to connect the lighting control devices, e.g. lights, light actuators and sensors, indicated in FIG. 2 in all rooms. In this example, all hall lights and sensors are powered via a single exclusive data-forwarding device, data switch S11. Whether or not lighting control devices within one room/hall maybe assigned to an exclusive data switch depends upon costs, the physical barriers of the building construction (breaking through walls and floors is expensive), maximum cable length, or entirely different causes and effects. Room B as depicted in FIG. 3 represents an example, where two data switches (i.e. data switches S4 and S10) are required to switch on all the lights in room B (i.e. lights L10 . . . L21). According to the above described light control scene all data switches apart from data switches S1 and S11 may be switched off in this example, since none of the lights in the other rooms need to be active. FIG. 4 shows an exemplary lighting control network 300 which comprises a set of lighting control components 301 such as sensors to detect a signal and actuators to switch an electrical load. The lighting control components 301 may be powered by a wired communication link or alternatively by an optional energy source or storage 330. The lighting control components 301 may be connected via wire or wirelessly to a border network component 101, which is part of communication network 100. The border network component 101 is connected to a management system via a network path in between 180, wherein the management system 200 in this case exemplary comprises an SDN system 230. The network path in between 180 is capable of passing and forwarding data according to rules (so called ‘flows’) programmed by the SDN system 230. The management system 200 may also comprise an SDA system 203 that has knowledge of the application plan 204, which stipulates which lighting control components 301 are required to engage in respective control scene. The SDA system 203 may as such generate the information that is required to switch off one or more components in the lighting control network 300, e.g. any subset of sensor(s) or actuator(s). Furthermore, the SDA system 203 controls the SDN system 230 to program the correct communication paths (filters with correct duration and addressing) and/or power change commands (on/off/idle/other power status level). In order to illustrate this exemplary embodiment a management system compromising an SDN and SDA system has been described. However, it is to be understood that any management system capable of configuring communication paths through the application network may be used instead.

According to the exemplary lighting control scene depicted in FIG. 2 data switches S1 and S11 are the only network component that need to be active. All other network components, namely data switches S2-S10 may be powered off entirely. However, it may be desirable to provide a finer granularity and allow single data ports of a data forwarding device serving a particular lighting control device to be powered off separately. For instance, at night it may suffice to only switch on every second light in the hall. Hence, every second data port of S11 may be switched off according to a corresponding lighting control scene. A further example, in which a data switch controllable at port-level would be advantageous, is when a data switch is shared between lighting control components in different rooms. Data ports serving lighting control components in a first room which according to a light control scene may not be lighted during a particular time of the day could be powered down, wherein data ports of the same data switch serving lighting control components in another room or hall during the same time should be active.

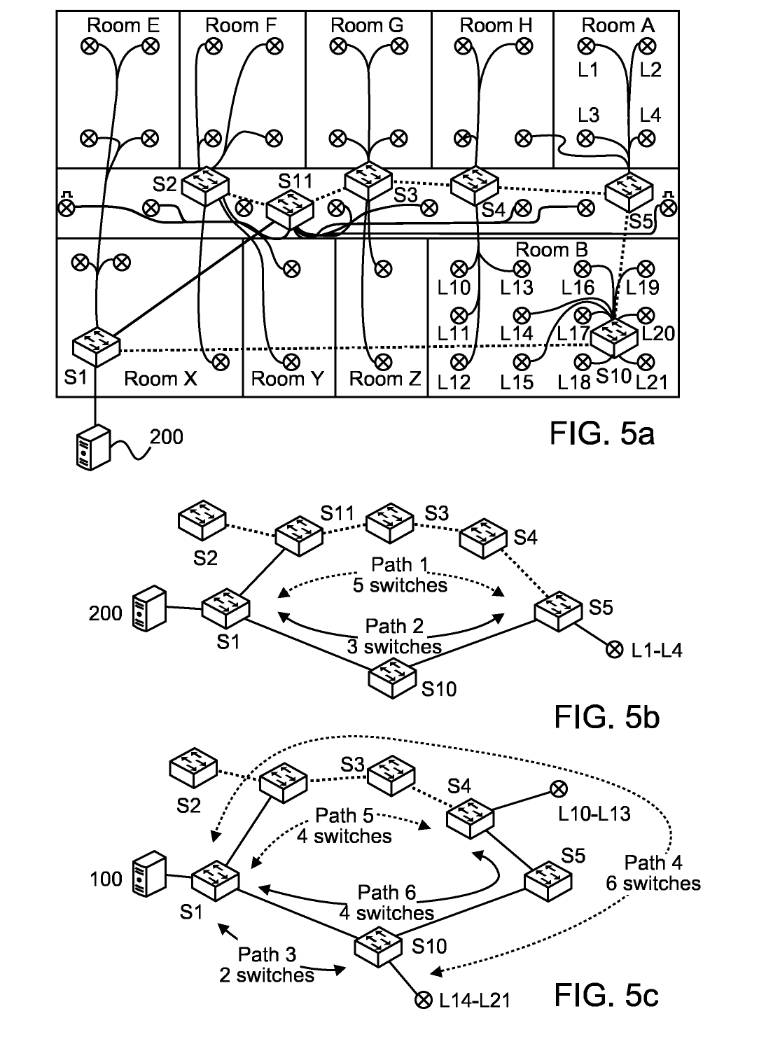

In a preferred embodiment knowledge collected by the management system 200 is used to enhance the decisions which communication paths to choose; that is the system may dynamically adapt the paths to choose for communication, e.g. due to changes in the network topology or the application usage. The path determination will be described with respect to a lighting control environment, as an exemplary application environment, where the “last drop cable” between the data switch and the light is assumed to be Power Over Ethernet (i.e. PoE). This PoE data switch is an all ports on/off device. So it may be energy efficient to switch off the entire switch. But as is shown in and discussed with respect to FIG. 3, a finer granularity may be required, since it may be desired to switch only 1 specific light that is part of a light (control) scene and served by a data switch serving a plurality of lights. However, the method presented in the following can also be applied to data-forwarding devices controllable on port level as discussed in co-pending patent application (Philips ref: 2015PF01070) by adapting the control scenes for each port of a data forwarding device. The method will exemplary be described for a lighting application. In this example the management system 200 is programmed to switch two lighting control scenes in arbitrary sequence, as shown in FIG. 5a-c, namely switch lights on in room A and room B.

Lighting control scene 1 as depicted in FIG. 5b defines to switch on all lights in room A. Starting from the “idle” network as shown in FIG. 3, the management system 200 calculates all available paths for sending a signal from the management system 200 to data switch S5. In this simplified example the possible paths are shown as path #1 and path #2. In the simple case that all data switches S1-S11 have the same energy requirements, the management system 200 will decide to use path #2 and switch on power to data switches S10 and S5 as this is considered the most energy efficient path to transfer commands to the lamps L1 . . . L4 in room A. In case the application control scene provides further knowledge regarding individual energy requirements of the data switches which may be extracted from a database, the management system may determine another way as being more energy efficient even though a larger number of data switches required along that path.

Subsequently, the use case of light control scene 2 as depicted in FIG. 5c is triggered to switch on lights in room B. Again the management system 200 will analyze the available paths to reach the group of lamps for this lighting scene, which in this case are connected to two separate data switches (i.e. S4 and S10).

The management system 200 decides that the combination of path #3 and path #6 is most energy efficient again assuming equal energy consumption of the data switches. Hence, compared to the previous light control scene 1 the management system will only switch on data switch S4 in addition. Although path #5 and path #6 require the same number of data switches to reach data switch S4 serving lamps L10-L13, the additional information from the application scene that half the path of path #6 is equal to path #3 which is the preferred path to switched on lamps L14-L21 enables the management system 200 to favors path #6 over path #5.

In a network topology with optimal redundancy and availability each data switch would be connected with each data switch to build a complete mesh. However, in a typical lighting network such a complete mesh is usually not necessary and often too costly. Thus, rather than building a perfect network topology with optimal redundancy, the network topology may be optimized to a suitable and acceptable solution.

Furthermore, due to changes of the application end nodes it may be possible that a previously adequate network topology is suddenly not suitable anymore. This can be caused by for example a change in the usage pattern, such as but not limited to:
Changes in ambient lighting levels (i.e. sun): short (e.g. weather) or long term (e.g. season),
Human usage: occupation, reorganization, rental contracts, overwork, etc.
Space assignment: office, lab, toilets, storage rooms, etc. all have different usage patterns.
External causes: traffic triggering adaptive dimming, burglar prevention, etc.

In that case the management system should be capable of accommodating these changes and to adaptively and dynamically select a better set of paths through the network than was previously the case.

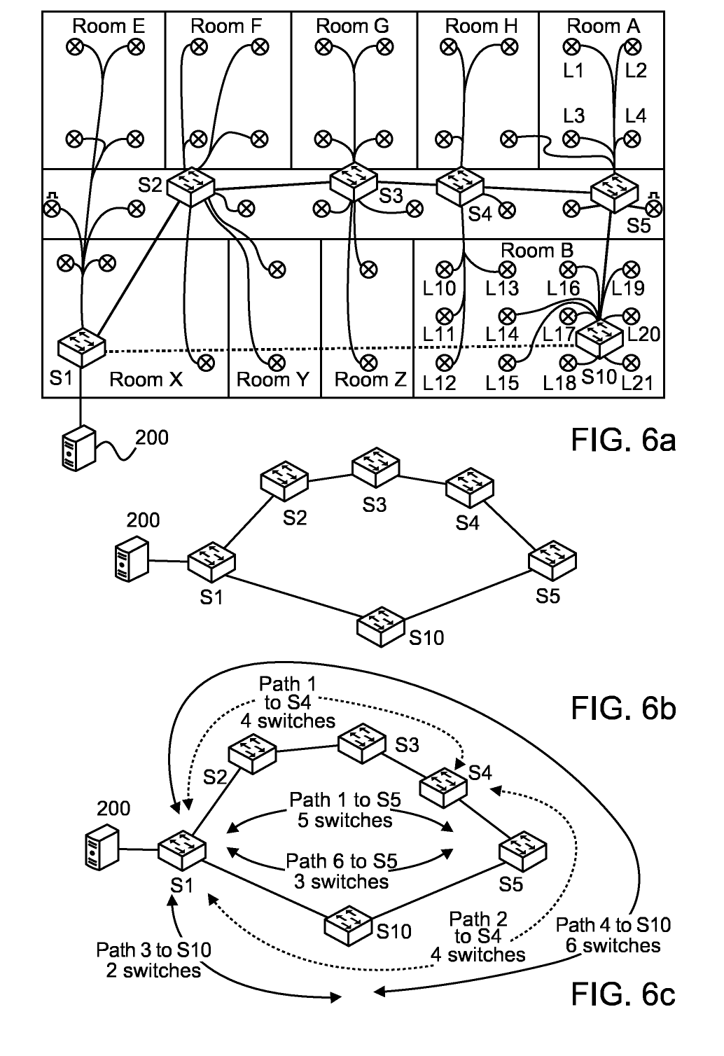

In order to do that an important aspect is to find the available paths, e.g. run update routines, and map them onto the application scenes, to determine which components along the paths shall remain powered while those components on unused paths can power themselves down. This process is explained with regard to FIG. 6 a-c. The example in FIG. 6a shows a limited number of paths to avoid a cluttered diagram. It is clear that already with a limited number of data-forwarding components in between a sensor and actuator, the number of potential paths can become quite large. In the case of the arbitrary ring network of FIG. 6a there are 82 possible paths between the 7 nodes (i.e. 1 management system controller end node 200 and 6 data switches: S1, . . . , S5+S10). Installing only a single cross cable between S3 and S10 would increase the number of paths through the network significantly.

The management system 200 is aware of all the paths that are possible and enabled to program the filters (i.e. communication path definitions) to pass data accordingly through the network. Different path definitions valid for certain periods in time, e.g. for given time slots, may be provided as timing schedules to the network components which may process the information in the schedule and power themselves down when not required.

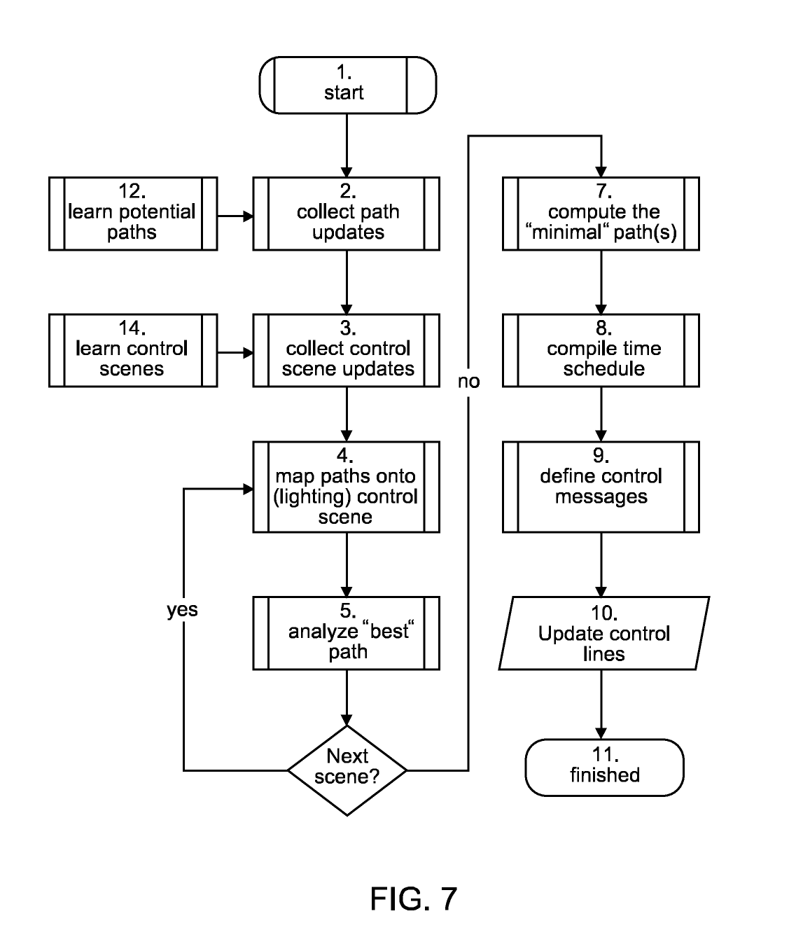

It shall be understood that many variants can be imagined to compute a time schedule as exemplary depicted in FIG. 7 for a lighting control application, wherein the sequence shown in FIG. 7 is one of a variety of alternative sequence.

The flow diagram starts (1) at a certain time interval. The system collects the path updates (2) of all potential paths that are known from the network. To be certain that the most recent collection of paths is used, a separate process will continuously learn potential paths through the network (12). The system then collects the lighting scene updates (3) of all lighting scenes in the lighting control network: the lighting scene shall define the sensors and actors that interact with each other and may define the action and duration thereof. To be certain that the most recent collection of lighting scenes is used, a separate process will continuously learn lighting scenes from the lighting control network (13). The system will subsequently map the lighting scenes onto the lighting control network (4) by defining the required paths in time to achieve the desired result. The system will then select the “best” path (5) to achieve the desired result of the control scene according to the constraints, which in this case is minimal energy usage but may include other constraints. The system may continue with all other lighting control scenes (6), as to accumulate a best path per lighting scene with the associated time and duration. Once the system completed a set of “best” paths for each lighting control scene, the system will check for time overlaps and will compute a (subset of) path(s) that most ideally supports lighting scenes in the control network (7). The system will then compile all paths defined in step (7) into one time schedule, which may define the timeslot immediately after the current. Most definitely the time schedule needs to specify the mode on the data-forwarding device, the route (i.e. path), start and stop time. To enhance flexibility and reduce data load for this provisional data protocol, many options could be conceivable for such a schedule, such as different block granularity, definition of very large and short time windows, checksums, etc. The system will check and filter for certain precedence, and avoid double definitions. An example of an arbitrary time schedule for energy saving is shown in the table below:

| | | | | | Stop time | |
|---|---|---|---|---|---|---|
| | | | Block | Start time | (current t + | |
| Path ID# | Mode | Route | granularity | (current t) | n* block) | Checksum |
| 1 | Persist | a-b-c | 10 seconds | Time t1 | Time t1 + 3 | CS1 |
| 2 | No_Hibernate | b-c-d-g-h | 15 mins | Time t1 | Time t1 + 3 | CS2 |
| 3 | Hibernate | b-c | 60 mins | Time t1 | Time t1 + 1 | CS3 |
| 5 | Persist | c-f-g-h-s | 60 mins | Time t2 | Time t2 + 24 | CS4 |
| 8 | On | * | 30 mins | Time t3 | Time t2 + 1 | CS5 |
| 9 | Off | d-e-f-h-k | 5 mins | Time t4 | Time t3 | CS6 |
| 21 | Hibernate | x-y-z | 60 mins | Time t5 | Time t4 + 4 | CS7 |

The system will subsequently define the appropriate data messages (9) to be send into the control network to update the control lines (10) “in efficio”. The system finishes the update of the control lines and the algorithm may be restarted after a certain interval.

The best path advisor computes a best path advice for the management system. The decision if the requested path is (im)possible may be augmented by additional considerations, such as for example (but not limited to):
A configurable granularity of the time that the path should be available.
A risk appetite, which may be fixed or dynamically updated, for example the amount of redundancy or availability or quality of service required of this path compared to alternative paths.

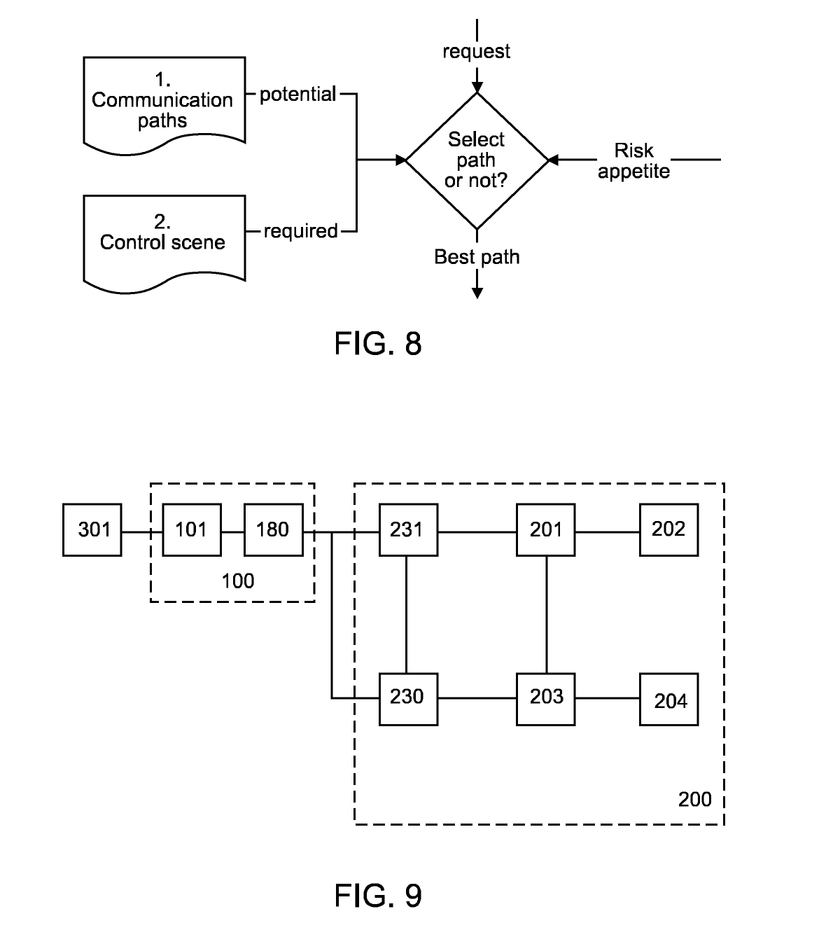

A typical decision is shown in FIG. 8. The system may use techniques to predict and optimize the availability of paths in certain time periods. Well-known methods, such as for example machine learning and/or (path) optimization using e.g. graphs, may be used by the system to determine if an improvement is possible and if so the system may give appropriate feedback or process the improvement into the schedule. Especially for the definition of communication paths with (much) longer duration, this may lower the provisional load of data messages onto the network and provide robustness of network operation when the management system would, for whatever reason, not be available.

In some embodiments different management systems may interact. For example, application networks in which the management system comprises an SDN system to program the communication path definitions, wherein the SDN system is connected to an SDA system to manage the application scenes, the SDN as well as the SDA systems may interact with other SDN or SDA systems. For instance, as shown in FIG. 9 SDL system 201 as one exemplary SDA system may interact with one or more other SDA systems 203 from other building works, e.g. “solar shading” or “Heating, ventilation and air conditioning (HVAC)” or entirely different building works. In that case the SDN system 231 should not switch off certain paths that could be required for the sensors and actuators in a application control scene of another building work. The SDN system 231 and/or SDL system 201 having knowledge of lighting plan 202 may communicate with SDN systems 230 and/or SDA system 203 having knowledge of application plan 204, e.g. HVAC plan, to collaborate and align the time schedules for the respective network components to avoid fratricide where both systems would actively be switching down each other required paths.

1. Method for controlling data routing within a control system comprising a plurality of network components, wherein the method comprises:
determining a first application scene defining one or more first destination devices among the plurality of network components to be controlled upon receipt of a message from one or more first source devices among the plurality of network devices;
selecting one or more respective communication paths through the network for communication between the one or more first source devices and the one or more first destination devices;
the respective communication paths based on an optimization of a predetermined parameter with respect to the first application scene,
configuring the network components to use the one or more selected communication paths from the plurality of communication paths for data routing; and
providing instructions to the network components which are not located along the one or more selected communication paths to operate in a power saving mode for a predetermined time given by the first application scene, wherein the network components in the power saving mode are not responsive to any network requests or messages.

2. Method according to claim 1, further comprising:
determining a second application scene defining a second destination device of the plurality of network devices to be controlled upon receipt of a message from a second source device of the plurality of network devices; wherein the second application scene precedes, follows or overlaps with the first application scene;
determining a second plurality of communication paths through the network for communication between the second source device and the second destination device;
selecting one or more respective communication paths from the second plurality of communication paths;
wherein selecting one or more respective communication paths from the first and second plurality of communication paths is based on an optimization of a predetermined parameter with respect to the first and second application scenes.

3. Method according to claim 1, wherein the plurality of network components comprise at least one data-forwarding device along the one or more selected communication paths, wherein the data-forwarding device comprises one or more data ports and the method further comprises:
providing instructions to the at least one data-forwarding device to operate the one or more data ports of the data-forwarding device which are not required for data communication along the one or more selected communication paths in a power saving mode.

4. Method according to claim 1, further comprising periodically searching for available communication paths within the network and if a new communication path is found and/or a communication path is no longer available, repeat the steps of selecting, configuring and providing instructions based on the updated communication paths.

5. Method according to claim 1, wherein the first application scene is determined from a usage pattern monitored during application usage, manually entered or uploaded from another storage source.

6. Method according to claim 2, further comprising:
generating respective time schedules for the network components defining operation states for the respective network components for respective time slots according to the first and second application scenes, and
providing the time schedules to the respective network components.

7. Method according to claim 1, wherein the predetermined parameter is one of time, frequency, duration, minimal energy usage or a combination thereof.

8. A computer program executable in a processing unit, the computer program comprising program code means for causing the processing unit to carry out a method as defined in claim 1 when the computer program is executed in the processing unit.

9. System for controlling data routing within a control network, the system comprising:
an application control unit for determining a first application scene defining one or more first destination devices among a plurality of network components to be controlled upon receipt of a message from one or more first source devices among the plurality of network devices;
a network control unit for determining a first plurality of communication paths through the network for communication between the one or more first source devices and the one or more first destination devices;
logic for selecting one or more respective communication paths from the plurality of communication paths based on an optimization of a predetermined parameter with respect to the first application scene,
wherein the network control unit is adapted to program the network components to use the one or more selected communication paths from the plurality of communication paths for data routing; and
wherein the application control unit is adapted to provide instructions to the network components which are not located along the one or more selected communication paths to operate in a power saving mode for a predetermined time given by the first application scene, wherein the network components in the power saving mode are not responsive to any network requests or messages.

10. System according to claim 9, wherein the application control unit is further adapted to determine a second application scene defining a second destination device of the plurality of network devices to be controlled upon receipt of a message from a second source device of the plurality of network devices; wherein the second application scene precedes, follows or overlaps with the first application scene;
the network control unit is further adapted to determine a second plurality of communication paths through the network for communication between the second source device and the second destination device;
the logic is further adapted to select one or more respective communication paths from the first and second plurality of communication paths based on an optimization of a predetermined parameter with respect to the first and second application scene.

11. System according to claim 9, wherein the plurality of network components comprise at least one data-forwarding device along the one or more selected communication paths, wherein the data-forwarding device comprises one or more data ports and the application control unit is further adapted to provide instructions to the at least one data-forwarding device to operate the one or more data ports of the data-forwarding device which are not required for data communication along the one or more selected communication paths in a power saving mode.

12. System according to claim 9, wherein the application control unit comprises a monitoring unit for monitoring application patterns during operation of an application to extract the first application scene.

13. System according to claim 9, wherein application control unit is further adapted to generate application schedules for unattended operation for the plurality of network components.

14. System according to claim 9, wherein the control network is shared by at least two application networks, and the system further comprises a second application control unit for determining a third application scene for a second application defining one or more destination devices among the plurality of network components to be controlled upon receipt of a message from one or more source devices among the plurality of network devices;
wherein the network control unit is adapted to determine a third plurality of communication paths through the network for communication between the one or more source devices and the one or more destination devices of the second application; and
wherein the logic is adapted to select one or more respective communication paths from the first and third plurality of communication paths based on an optimization of a predetermined parameter with respect to the first and third application scene.

15. System according to claim 9, wherein the control network is shared by at least two application networks, and the system further comprises a second application control unit for determining a third application scene for a second application defining one or more destination devices among the plurality of network components to be controlled upon receipt of a message from one or more source devices among the plurality of network devices;
wherein the system comprises a second network control unit for determining a third plurality of communication paths through the network for communication between the one or more source devices and the one or more destination devices of the second application; and
wherein the logic is adapted to select one or more respective communication paths from the first and third plurality of communication paths based on an optimization of a predetermined parameter with respect to the first and third application scene, and wherein the respective network control units are adapted to program the network components to use the one or more selected communication paths from the plurality of communication paths for data routing.
